(19) United States
(12) Patent Application Publication
(10) Pub. No.: US 2022/0203437 A1
(43) Pub. Date: Jun. 30, 2022

(54) TUNABLE REACTIVE ALUMINUM SLURRY FUEL

(71) Applicant: Massachusetts Institute of Technology, Cambridge, MA (US)

(72) Inventors: Eric Morgan, Bolton, MA (US); Andrew Whitehead, Somerville, MA (US)

(73) Assignee: Massachusetts Institute of Technology, Cambridge, MA (US)

(21) Appl. No.: 17/508,324

(22) Filed: Oct. 22, 2021

Related U.S. Application Data
(60) Provisional application No. 63/132,161, filed on Dec. 30, 2020.

(51) Int. Cl. B22F 1/00; C01B 3/08

(52) U.S. Cl. CPC B22F 1/0088; B22F 2301/052; B22F 2001/0092; C01B 3/08

(57) ABSTRACT

The reaction between aluminum metal and water holds promise for producing hydrogen; however, solid aluminum metal is difficult to manage and use, and the reactivity between aluminum and water is often difficult to control. Certain embodiments of the disclosure are related to a water-stable aluminum slurry comprising a plurality of activated aluminum particles dispersed in a fluid carrier. In some embodiments, the reactivity of the aluminum slurry in the presence of water may be easily controlled with the addition of various additives (e.g., surfactants). Additionally, methods of making and using the water-stable aluminum slurry to controllable manage the reactivity between aluminum and water are presented herein.

### CROSS-REFERENCE TO RELATED APPLICATIONS

This application claims the benefit under 35 U.S.C. § 119(e) of U.S. provisional application Ser. No. 63/132,161, filed Dec. 30, 2020, the disclosure of which is incorporated herein by reference in its entirety.

### GOVERNMENT LICENSE RIGHTS

This invention was made with Government support under Grant No. FA8702-15-D-0001 awarded by the U.S. Air Force. The Government has certain rights in the invention.

### FIELD

Disclosed embodiments are related to controlling the reactions of reactive aluminum slurry fuel with water.

### BACKGROUND

Aluminum's high energy density, alongside its value as a structural material, makes it a promising energy vector for many applications. Aluminum, when reacted with water, is capable of generating hydrogen, heat, and aluminum hydroxide as byproducts. Accordingly, aluminum has been used as a source of hydrogen and heat supply for various applications.

### SUMMARY

In one embodiment, an aluminum slurry includes: a plurality of activated aluminum particles dispersed in a fluid carrier, wherein the activated aluminum particles comprises aluminum combined with gallium and/or indium; and a surface layer disposed on the plurality of activated aluminum particles, wherein the surface layer comprises a hydrophobic material having an affinity to the surface of the activated aluminum particles, and wherein the hydrophobic material has a melting point of greater than 20° C. and less than or equal to 100° C.

In one embodiment, a composition includes: an aluminum slurry including a plurality of activated aluminum particles dispersed in a fluid carrier, wherein the activated aluminum particles comprise aluminum combined with gallium and/or indium; and a surface layer disposed on the plurality of activated aluminum particles, wherein the surface layer comprises a hydrophobic material having an affinity to the surface of the activated aluminum particles; and an initiator uniformly dispersed in the composition, wherein the initiator comprises a hydrophilic surfactant selected from the group of non-ionic and ionic surfactants.

In one embodiment, a method of using an aluminum slurry includes: adding an initiator to a composition containing an aluminum slurry, wherein the aluminum slurry comprise a plurality of activated aluminum particles dispersed in a fluid carrier, wherein the activated aluminum particles comprises aluminum combined with gallium and/or indium; and disrupting a surface layer disposed on the plurality of activated aluminum particles with the initiator to permit a reaction between the plurality of activated aluminum particles in the aluminum slurry and water.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic depiction of an activated aluminum particle, according to certain embodiments;

FIG. 2 is a schematic depiction of an aluminum slurry, according to certain embodiments;

FIG. 3 is a schematic depiction of a reactor system configured to react an aluminum slurry with water, according to certain embodiments;

FIG. 4 is a flow diagram of a method for making and using an aluminum slurry, according to certain embodiments; and

FIG. 5 is a schematic depiction of a reactor containing a composition of water, an initiator, and an aluminum slurry, according to certain embodiments.

### DETAILED DESCRIPTION

Aluminum's high energy density makes it a promising energy vector for many applications including hydrogen generation, water distillation, and heating. For instance, the generated hydrogen may be used to power UxVs, to evacuate mining channels, or stored for other uses. However, solid materials (e.g., solid aluminum) is challenging to measure, handle, and manage in an engineered system. On the other hand, liquids are relatively easy to measure, handle, and manage because they can be easily stored in tanks and easily transported from one location to another (e.g., pumped using conventional equipment).

Additionally, while aluminum may react with water (e.g., see eq. (1)), the inventors have recognized that there is a lack of suitable methods that can be used to control the reaction between aluminum and water.

2Al(s)+6H₂O→3H₂+2Al(OH)₃+Heat (1)

As shown in Eq. (1), solid aluminum may react with water to generate hydrogen and aluminum hydroxide. Typically, this exothermic reaction can lead to a rapid production of heat as well as a rapid formation of a layer of crust at the interface between aluminum and water. As a result, potential issues such as incomplete reactions (e.g., caused by the formation of the crust layer separating the aluminum and water), uncontrollable reaction rates, and a rapid increase in temperature in the reactor may arise.

In view of the above, the Inventors have appreciated that the use of a liquid aluminum fuel may increase the ease and safety of manufacturing, handling, transporting, and use of the fuel. Additionally, the Inventors have recognized a need to control the reaction rates in order to increase the efficiency and safety of the reaction. Accordingly, certain embodiments of the disclosure are related to the formation and use of an aluminum slurry comprising a plurality of activated aluminum particles dispersed in an inert fluid carrier (e.g., oil and/or alcohol). Advantageously, the fluid carrier may enhance the stability of the aluminum fuel by reducing the potential dispersion of the aluminum particles in air, and at the time, increase the ease of transporting and using the aluminum fuel. Additionally, certain embodiments of the disclosure are related to the formation and use of a composition comprising the aluminum slurry, water, and various materials (e.g., hydrophobic material including hydrophobic surfactants and/or lipids, initiators including hydrophilic surfactants) that may be used to modulate the reaction rates between aluminum and water. That is, these materials may serve as “locks,” e.g., materials that can prevent the reaction from occurring, or “keys,” e.g., materials that can initiate the reaction between aluminum and water.

As mentioned, certain embodiments of the disclosure are related to an aluminum slurry comprising a plurality of activated aluminum particles dispersed in a fluid carrier. The term “activated aluminum particles” refers to aluminum particles that contain an activating composition (e.g., gallium and/or indium) that may facilitate the reaction of aluminum with water, as described elsewhere herein. In some embodiments, a surface layer is disposed on the plurality of activated aluminum particles, at the interface between the surface of the activated aluminum particles and the fluid carrier. In some cases, the surface layer may include a hydrophobic material that is soluble in the fluid carrier and also has an affinity to the surface of the activated aluminum particles, such that the hydrophobic material may preferentially bind and/or deposit on the surface of the activated aluminum particles. For instance, the hydrophobic material may include a surfactant of a first type described elsewhere herein that contains both a hydrophobic portion and a hydrophilic portion, where the hydrophilic portion of the surfactant can provide a driving force for the surfactant of the first type to preferentially accumulate at the surface of the activated aluminum particles to form surfactant layers. In some embodiments, the surface layer substantially coats and prevents reaction between the coated particles and a surrounding environment. That is, the presence of the surface layer may act as a physical and/or chemical barrier that prevents interaction of the particles with the surrounding environment (e.g., water). As a result, the reactivity of activated aluminum particles may be substantially lowered.

In some embodiments, a composition including an aluminum slurry is provided herein. In some such embodiments, the composition comprises an aluminum slurry described above, water, and an initiator that is uniformly dispersed in the composition. As described elsewhere herein, the initiator may be a surfactant of a second type that can interact with the hydrophobic material (e.g., a surfactant of the first type) in the surface layer disposed on the plurality of activated aluminum particles. For instance, the initiator may be configured to disrupt the surface layer on the plurality of activated aluminum particles to permit a reaction between the plurality of activated aluminum particles in the aluminum slurry and water. In some such embodiments, while the hydrophobic material in the surface layer acts as a “lock” that is configured to substantially prevent the reaction between aluminum particles and the surrounding environment (e.g., water), and the initiator may act as a “key” that disrupts the surface layer to selectively permit the reaction between aluminum and water. In general, the composition may allow for a facile and tunable method of controlling the timing of the reaction as well as the reaction rate between the activated aluminum particles and water. The specifics of using the composition is presented in more details below.

In some embodiments, a method of using an aluminum slurry described above is provided herein. In one set of embodiments, the method includes adding an initiator to a composition containing an aluminum slurry. In some such embodiments, the aluminum slurry may be combined with water to form a composition prior to adding the initiator. In some such embodiments, the aluminum slurry is stable and substantially unreactive in the presence of water prior to adding the initiator. As mentioned previously, each of the plurality of activated aluminum particles may be at least partially coated by the surface layer, such that the surface layer can prevent the reaction of the activated aluminum particles with the surrounding environment (e.g., water) prior to adding the initiator. In some embodiments, as the initiator is added to the aluminum slurry and water, the surface layer on the plurality of activated aluminum particles may be disrupted to allow the plurality of activated aluminum particles to react with the surrounding environment (e.g., water). For instance, after the disruption of the surface layer on the plurality of activated aluminum particles, the reaction between the plurality of activated aluminum particles and water may take place and generate hydrogen, heat, and aluminum hydroxide.

In some embodiments, the plurality of activated aluminum may comprise an activating composition that is permeated into the grain boundaries and/or subgrain boundaries of the aluminum to facilitate its reaction with water. For example, the activated aluminum particles may include aluminum combined with gallium and/or indium. In some instances, the activating composition may be an eutectic, or close to eutectic composition, including for example an eutectic composition of gallium and indium. In one such embodiment, the activating composition may comprise gallium and indium where the portion of the activating composition may have a composition of about 70 wt %-80 wt % gallium and 20 wt % to 30 wt % indium though other weight percentages are also possible. Without wishing to be bound by theory, gallium and/or indium may permeate through the one or more grain boundaries and/or subgrain boundaries of the reactant (e.g., metal). For instances, the activating composition may be incorporated into an alloy with the reactant (e.g., metals such as aluminum). A metal alloy may comprise any activating composition in any of a variety of suitable amounts. In some embodiments, for example, the metal alloy comprises greater than or equal to 0.1 wt % of the activating composition, greater than or equal to 1 wt %, greater than or equal to 5 wt %, greater than or equal to 15 wt %, greater than or equal to 30 wt %, or greater than or equal to 45 wt % of the activating composition based on the total weight of the metal alloy. In certain embodiments, the metal alloy comprises less than or equal to 50 wt %, less than or equal to 40 wt %, less than or equal to 30 wt %, less than or equal to 20 wt %, less than or equal to 10 wt %, less than or equal to 5 wt %, or less than or equal to 1 wt % of the activating composition, based on the total weight of the metal alloy. Combinations of the above recited ranges are also possible (e.g., the metal alloy comprises greater than or equal to 0.1 wt % and less than or equal to 50 wt % of the activating composition based on the total weight of the metal alloy, the metal alloy comprises greater than or equal to 1 wt % and less than or equal to 10 wt % of the activating composition based on the total weight of metal alloy). Other ranges are also possible.

In some embodiments, the plurality of activated aluminum particles may be present in any appropriate amount in the aluminum slurry. In some embodiments, the plurality of activated aluminum particles may be present in an amount of greater than or equal to 5 wt %, greater than or equal to 10 wt %, greater than or equal to 20 wt %, greater than or equal to 30 wt %, greater than or equal to 40 wt %, greater than or equal to 50 wt %, greater than or equal to 55 wt %, greater than or equal to 70 wt %, or greater than or equal to 80 wt % of a total weight of the aluminum slurry. In some embodiments, the plurality of activated aluminum particles may be present in an amount of less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 15 wt %, or less than or equal to 10 wt % the total weight of aluminum slurry. Combinations of the above-referenced ranges are also possible (e.g., greater than or equal to 10 wt % and less than or equal to 90 wt %, or greater than or equal to 50 wt % and less than or equal to 90 wt %). Other ranges are also possible.

In some embodiments, a reactant may be provided in the form of a slurry that combines the reactant material (e.g., activated aluminum particles) with a non-reactive fluid carrier. For example, a slurry may include particles of the reactant material suspended in an inert fluid. In some embodiments, the fluid may be an oil, such as mineral oil, diesel fuel, canola oil, or olive oil. In other embodiments, the fluid may be a grease, alcohol, or other appropriate material capable of suspending the reactant material in solution. In some embodiments, the diameter of the particles in the slurry may be between approximately 10 micrometers to 200 micrometers, 10 micrometers to 50 micrometers, and/or any other appropriate size range depending on the particular embodiment. In one embodiment, a slurry may be produced in a colloid mill, although other methods of producing a slurry are also contemplated as the disclosure is not limited in this regard.

It should be understood that a slurry may have any appropriate ratio of the reactant (e.g., activated aluminum particles) to fluid carrier by weight. Further, without wishing to be bound by theory, the ratio of the reactant material to liquid carrier in the slurry may affect both the physical properties of the slurry as well as the performance of the system. For example, a slurry that has a reactant/carrier ratio of 90:10 by weight may be characterized as a paste, whereas a slurry with a 50:50 ratio may flow more easily. In some applications, a reactant/carrier ratio as low as 10:90 may be desirable. Accordingly, a ratio of a reactant to fluid carrier by weight may be between about 10:90 and 90:10, though other appropriate ranges both greater and less than those noted above are also contemplated.

In some embodiments, the plurality of activated aluminum particles may have a variety of average particle sizes corresponding to an average maximum dimension of the particles. The average particle size may be any suitable average, such as a number-based average, volume-based average, or intensity-based average (otherwise known as Z-average). In some cases, the plurality of active aluminum particles may have an average size of greater than or equal 5 μm, greater than or equal to 10 μm, greater than or equal to 25 μm, greater than or equal to 50 μm, greater than or equal to 75 μm, greater than or equal to 100 μm, greater than or equal to 150 μm, greater than or equal to 200 μm, greater than or equal to 300 μm, greater than or equal to 400 μm, greater than or equal to 500 μm, greater than or equal to 600 μm, or greater than or equal to 800 μm. In some embodiments, the plurality of active aluminum particles may have an average particle size of less than or equal to 1000 μm, less than or equal to 800 μm, less than or equal to 600 μm, less than or equal to 500 μm, less than or equal to 400 μm, less than or equal to 300 μm, less than or equal to 200 μm, less than or equal to 150 μm, less than or equal to 100 μm, less than or equal to 75 μm, less than or equal to 50 μm, less than or equal to 25 nm, less than or equal to 10 μm, or less than or equal to 5 μm. Combinations of the above-referenced ranges are also possible (e.g., greater than or equal to 10 μm and less than or equal 100 um, greater than or equal to 10 μm and less than or equal to 1000 μm). Other ranges are also possible.

It should be noted that the plurality of activated aluminum particles may have any suitable shape. For instance, the particles may be regularly shaped, such as spherical, or may be irregularly shaped chunks. The solid reactant may be provided in a more continuous form, such as a powder with any appropriate size distribution for a desired application.

According to some embodiments, a plurality of activated aluminum particles may be dispersed in a fluid carrier (e.g., oil and/or alcohol). It should be noted that the fluid carrier is an inert fluid such that is unreactive to any materials in the composition described herein (e.g., activated aluminum particles, hydrophobic materials disposed on the aluminum particles, additives, water, etc.). In some such embodiments, the fluid carrier may include a fluid selected from the group of oil (e.g., petroleum-derived products, including mineral oil and diesel fuel; food-grade oils), and/or branched alcohols (e.g., isopropanol or isobutanol).

In some embodiments, the fluid carrier may be present in any appropriate amount in the aluminum slurry. In some embodiments, the fluid carrier may be present in an amount of greater than or equal to 5 wt %, greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, or greater than or equal to 80 wt % of the aluminum slurry. In some embodiments, the fluid carrier may be present in an amount of less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, or less than or equal to 10 wt % of the total weight of aluminum slurry. Combinations of the above-referenced ranges are also possible (e.g., greater than or equal to 10 wt % and less than or equal to 90 wt %). Other ranges are also possible.

In some embodiments, a fluid carrier may have a relatively low freezing point such that the fluid carrier remains as a liquid above its freezing point. In some embodiments, the fluid carrier may have a freezing point of less than or equal to 25° C., less than or equal to 20° C., less than or equal to 15° C., less than or equal to 10° C., less than or equal to 5° C., less than or equal to 0° C., less than or equal to −5° C., less than or equal to −10° C., less than or equal to −15° C., less than or equal to −20° C. or less than or equal to −25° C. For instance, in a specific embodiment, the fluid carrier has a freezing point of less than or equal to 20° C. However, it should be noted that a fluid carrier may have any suitable freezing point (e.g., greater than 20° C., greater than 25° C., etc.), as long as the fluid carrier can be used to form an aluminum slurry described herein. For instance, in one set of embodiments, the fluid carrier may have a freezing temperature that is lower than a processing temperature inside a mill (e.g., a mill used to form the aluminum slurry), such that the fluid carrier is a liquid inside the mill, and such that the activated aluminum particles may be dispersed uniformly in the fluid carrier. The processing temperature may be the temperature inside a mill, or any suitable equipment that is used to form the aluminum slurry. In some embodiments, the processing temperature may be greater than or equal to room temperature (e.g., 20° C.).

In accordance with some embodiments, each of the plurality of activated aluminum particles described herein is at least partially coated by a surface layer. For instance, in some embodiments, an activated aluminum particle that is at least partially coated by the surface layer may refer to an activated aluminum particle that is at least 10%, at least 20%, 30%, at least 40%, at least 50%, at least 60%, at least 70%, at least 80%, at least 90%, or at least 99% coated by the surface layer. In some embodiments, the activated aluminum particle may be substantially or fully coated by the surface layer. As mentioned, the surface layer may be configured to isolate the activated aluminum particles from the surrounding environment and potentially reactive species in the surrounding environment (e.g., water, fluid carrier, additives, etc.).

Without wishing to be bound by theory, it has been hypothesized that a surface layer disposed on the plurality of the activated aluminum particles may prevent the reaction between aluminum and water by isolating the activated aluminum particles from water either physically and/or chemically. For instance, in one set of embodiments, the surface layer may comprise a hydrophobic material that have a relatively high melting temperature, such that the surface layer is a solid layer that can physically block water from penetrating into the solid surface layer and contacting the surface of the activated aluminum particles. Additionally, the highly hydrophobic nature of the surface layer may make it energetically and chemically unfavorable for the surface-coated activated aluminum particles to be in proximity with water. In some such cases, the surface-coated activated aluminum particles may preferentially remain in an oil phase (e.g., fluid carrier) as opposed to an aqueous phase (e.g., water). As such, the oil phase (e.g., fluid carrier) may act as a second barrier blocking water from contacting the activated aluminum particles, in addition to the surface layer on the plurality of particles. It should be noted that the surface layer is not limited to being in the form a solid surface layer; the surface layer may remain in a fluid state (e.g., liquid surface layer), as long as the surface layer is capable of acting as an barrier that shields the activated aluminum particles from the surrounding environment (e.g., water).

In some embodiments, a hydrophobic material may have a melting point of greater than a typical environmental temperature (e.g., room temperature of about 20° C.) and less than or equal to an operating temperature (e.g., about 100° C.) inside a reactor (e.g., the reactor where the reaction between water and aluminum may take place). For instance, it may be favorable for the surface layer containing the hydrophobic material to remain as a solid coating prior to the reaction between water and aluminum in the reactor. As such, the solid surface layer may act as a physical barrier between the aluminum and the surrounding environment.

In some embodiments, the hydrophobic material may have a variety of suitable melting points. For instance, the hydrophobic material may have a melting point of greater than or equal to 40° C., greater than or equal to 50° C., greater than or equal to 60° C., greater than or equal to 70° C., greater than or equal to 80° C., greater than or equal to 90° C., or any other appropriate temperature. In some embodiments, the hydrophobic material may have a melting point of less than or equal to 100° C., less than or equal to 90° C., less than or equal to 80° C., less than or equal to 70° C., less than or equal to 60° C., less than or equal to 50° C., or any other appropriate temperature. Combinations of the above-referenced ranges are also possible (e.g., greater than 40° C. and less than or equal to 100° C.). Other ranges are also possible depending on the particular operating temperatures and materials used.

In some embodiments, a reactor may have a variety of appropriate operating temperatures. For instance, the operating temperature inside the reactor may be greater than or equal to 0° C. and less than or equal to 300° C.

In some embodiments, the hydrophobic material may include a hydrophobic surfactant and/or a lipid. In some such embodiments, the lipid may be a fat and/or a wax, or any other types of lipid that has a melting point disclosed above. In some embodiments, the hydrophobic material described herein may contain a small portion (e.g., a hydrophilic portion) that has an affinity to the activated aluminum particles, such that the hydrophobic material preferentially deposits on the surface of the activated aluminum particles. For example, the hydrophobic material may be a surfactant, as described herein.

In some embodiments, the hydrophobic material may include a surfactant of a first type, such as a hydrophobic surfactant. As is well known in the art, a surfactant is typically an amphiphilic compound, meaning that it contains both hydrophobic portions (e.g., non-polar groups) that are oil-soluble and hydrophilic portions (e.g., polar or charged groups) that are water-soluble. Owing to their amphiphilic nature, surfactant molecules can preferentially pack between two insoluble phases (e.g., interface between an oil and water). Hence, for a surfactant molecule, the terms “hydrophilic” and “hydrophobic” are relative terms. For instance, while a hydrophobic surfactant has a greater solubility in oils, a hydrophilic surfactant may have a greater solubility in aqueous mediums.

According to some embodiments, the hydrophobic material described herein comprises a hydrophobic surfactant that has a greater solubility in an oil phase (e.g., fluid carrier) than in an aqueous phase (e.g., water). It should be noted that although the hydrophobic surfactant is soluble in the oil phase, the hydrophobic surfactant still contains a relatively smaller hydrophilic portion that has an affinity to the activated aluminum particles. Accordingly, in the presence of activated aluminum particles, it may be energetically favorable for the hydrophobic surfactant to deposit at the solid-liquid (e.g., aluminum-fluid carrier) interface, with its hydrophilic portion orienting towards the aluminum surface, and its hydrophobic portion orienting towards the fluid carrier (e.g., an oil and/or alcohol). In some such embodiments, the surface layer disposed on the activated aluminum particles is a surfactant layer. It should be noted that such a surfactant layer may reduce the interfacial tension between the activated aluminum particle and the fluid carrier, thus stabilizing the dispersion of the activated aluminum particles in the fluid carrier and resulting in a stable aluminum slurry.

In some embodiments, the hydrophobic material (e.g., hydrophobic surfactant and/or lipid) comprises at least one selected from the group of tallow, aluminum stearate, fatty acids, waxes, and grease. In some cases, the hydrophobic material may be a mixture of the above-mentioned species or derivatives thereof. In one set of embodiments, tallow (e.g., predominantly consists of triglycerides), which belongs to the class of lipids, may exhibit behaviors of a hydrophobic surfactant. For instance, tallows may comprise a hydrophobic portion that is responsible for solubilizing the surfactant in the fluid carrier and a hydrophilic portion that has an affinity to the surface of the activated aluminum particles. As such, it may be energetically favorable for the hydrophilic portion of tallow to deposit on the surface of the activated aluminum particle and the hydrophobic portion of tallow to be solubilized in the fluid carrier, such that a surface layer (e.g., surfactant layer) may be formed on the activated aluminum particles. In another set of embodiments, fatty acids may exhibit behaviors of hydrophobic surfactants similar to that of tallow. Non-limiting examples fatty acids may include as palmitic acid, stearic acid, myristic acid, arachidic acid, oleic acid, palmitoleic acid, linoleic acid, and linolenic acid.

As mentioned previously, the hydrophobic surfactant may have a greater solubility in an oil phase (e.g., fluid carrier) than in an aqueous medium (e.g., water). In some such embodiments, the hydrophobic surfactant may be selected from the group of non-ionic surfactants. An empirical parameter that is be commonly used to characterize the relative hydrophilicity and hydrophobicity of non-ionic amphiphilic surfactants is the hydrophilic-lipophilic balance, also known as the HLB value. For instance, whereas surfactants having a lower HLB values tend to be more hydrophobic and has greater solubility in oils, surfactants having a higher HLB values tend to be more hydrophilic and has greater solubility in aqueous mediums. Generally, a hydrophilic non-ionic surfactant tends to have a HLB value of greater than about 10, while a hydrophobic non-ionic surfactant tend to have a HLB value of less than about 10.

In some embodiments, a hydrophobic non-ionic surfactant described herein may have an HLB value of less than about 10, less than about 8, less than about 6, less than about 4, or less than about 2. For instance, non-limiting examples of hydrophobic surfactants may be selected from the group of glycerol fatty acid esters; polyoxyethylene alkylethers; fatty acids; bile acids; alcohols; acetylated glycerol fatty acid esters; lower alcohol fatty acids esters; polyethylene glycol fatty acids esters; polyethylene glycol glycerol fatty acid esters; polypropylene glycol fatty acid esters; polyoxyethylene glycerides; lactic acid esters of mono/diglycerides; propylene glycol diglycerides; sorbitan fatty acid esters; polyoxyethylene sorbitan fatty acid esters; polyoxyethylene-polyoxypropylene block copolymers; transesterified vegetable oils; sterols; sugar esters; sugar ethers; sucroglycerides; polyoxyethylene vegetable oils; polyoxyethylene hydrogenated vegetable oils; reaction mixtures of polyols and at least one member of the group consisting of fatty acids, vegetable oils, glycerides, hydrogenated vegetable oils, and sterols; and mixtures thereof.

Specific examples of the above-mentioned class of hydrophobic surfactant include, but is not limited to myristic acid; oleic acid; lauric acid; stearic acid; palmitic acid; PEG 1-4 stearate; PEG 2-4 oleate; PEG-4 dilaurate; PEG-4 dioleate; PEG-4 distearate; PEG-6 dioleate; PEG-6 distearate; PEG-8 dioleate; PEG 3-16 castor oil; PEG 5-10 hydrogenated castor oil; PEG 6-20 corn oil; PEG 6-20 almond oil; PEG-6 olive oil; PEG-6 peanut oil; PEG-6 palm kernel oil; PEG-6 hydrogenated palm kernel oil; PEG-4 capric/caprylic triglyceride, mono, di, tri, tetra esters of vegetable oil and sorbitol; pentaerythrityl di, tetra stearate, isostearate, oleate, caprylate, or caprate; polyglyceryl 2-4 oleate, stearate, or isostearate; polyglyceryl 4-10 pentaoleate; polyglyceryl-3 dioleate; polyglyceryl-6 dioleate; polyglyceryl-10 trioleate; polyglyceryl-3 distearate; propylene glycol mono- or diesters of a C6 to C22 fatty acid; monoglycerides of a C6 to C22 fatty acid; acetylated monoglycerides of a C6 to C22 fatty acid; diglycerides of C6 to C22 fatty acids; lactic acid esters of monoglycerides; lactic acid esters of diglycerides; cholesterol; phytosterol; PEG 5-20 soya sterol; PEG-6 sorbitan tetra, hexastearate; PEG-6 sorbitan tetraoleate; sorbitan monolaurate; sorbitan monopalmitate; sorbitan mono, trioleate; sorbitan mono, tristearate; sorbitan monoisostearate; sorbitan sesquioleate; sorbitan sesquistearate; PEG 2-5 oleyl ether; POE 2-4 lauryl ether; PEG-2 cetyl ether; PEG-2 stearyl ether; sucrose distearate; sucrose dipalmitate; ethyl oleate; isopropyl myristate; isopropyl palmitate; ethyl linoleate; isopropyl linoleate; poloxamers; cholic acid; ursodeoxycholic acid; glycocholic acid; taurocholic acid; lithocholic acid; deoxycholic acid; chenodeoxycholic acid; and mixtures thereof.

In some embodiments, a hydrophobic material may be present in a relatively small amount in the aluminum slurry described herein. In some embodiments, the hydrophobic material is present in an amount of greater than or equal or equal to greater than or equal to 0.01 wt %, greater than or equal to 0.05 wt %, greater than or equal to 0.1 wt %, greater than or equal to 0.25 wt %, greater than or equal to 0.5 wt %, greater than or equal to 0.75 wt %, greater than or equal to 1 wt %, greater than or equal to 2 wt %, greater than or equal to 3 wt %, or greater than or equal to 4 wt % of a total weight of the aluminum slurry. In some cases, the hydrophobic material may be present in an amount of less than or equal to 5 wt %, less than or equal to 4 wt %, less than or equal to 3 wt %, less than or equal to 2 wt %, less than or equal to 1 wt %, less than or equal to 0.75 wt %, less than or equal to 0.5 wt %, less than or equal to 0.25 wt %, less than or equal to 0.1 wt %, or less than or equal to 0.05 wt % of a total weight of the composition. Combinations of the above-referenced ranges are also possible (e.g., greater than or equal to 0.05 wt % and less than or equal to 1 wt %, or greater than or equal to 0.05 wt % and less than or equal to 5 wt %). Other ranges are also possible.

As mentioned previously, an initiator may be added to an aluminum slurry described herein to disrupt a surface layer disposed on the plurality of the activated aluminum particles. In some embodiments, the initiator (e.g., a surfactant of a second type) may interact with the hydrophobic material (e.g., a surfactant of a first type) in the surface layer in a way that destabilizes and disrupts the surface layer. In some such embodiments, the addition of an initiator (e.g., hydrophilic surfactant) may disrupt the surface layer (e.g., surfactant layer) formed by the hydrophobic material (e.g., hydrophobic surfactant) and lead to a destabilization of the aluminum slurry. The surface layer, once disrupted, may allow for reactive species (e.g., water) from the surrounding environment to reach and react with the aluminum particle.

In one set of embodiments, the hydrophobic material and the initiator may be surfactants of different polarities. For instance, the initiator may be a hydrophilic surfactant and the hydrophobic material maybe a hydrophobic surfactant. In one set of embodiments, the hydrophobic material and the initiator may be non-ionic surfactants with different HLB values. For instance, the initiator may be a surfactant with a HLB value of greater than about 10 and the hydrophobic material may be a surfactant with a HLB of less than about 10. In another set of embodiments, the hydrophobic material may include a non-ionic surfactant and the initiator may include a surfactant selected from the group of non-ionic and ionic surfactants.

As mentioned, in some embodiments, the initiators may include a hydrophilic surfactant selected from the group of non-ionic and ionic surfactants (e.g., anionic, cationic, zwitterionic). In some embodiments, a hydrophilic surfactant may be a surfactant that produces relatively less foam, such as ionic surfactants. Examples of hydrophilic surfactant include detergents, soap, POP 2500/20% EtO.

In some cases, the initiator may comprise a hydrophilic surfactant. In some such embodiments, the hydrophilic non-ionic surfactant may have an HLB value of greater than about 10. Non-limiting examples of the non-ionic hydrophilic surfactant may be selected from the group of polyoxyethylene alkylethers; polyethylene glycol fatty acids esters; polyethylene glycol glycerol fatty acid esters; polyoxyethylene sorbitan fatty acid esters; polyoxyethylene-polyoxypropylene block copolymers; polyglycerol fatty acid esters; polyoxyethylene glycerides; polyoxyethylene vegetable oils; polyoxyethylene hydrogenated vegetable oils; reaction mixtures of polyols and at least one member of the group consisting of fatty acids, glycerides, vegetable oils, hydrogenated vegetable oils, and sterols; and mixtures thereof.

In some embodiments, the initiator may comprise a hydrophilic surfactant selected from a group of ionic surfactants including anionic, cationic, and zwitterionic surfactants. In some embodiments, an hydrophilic ionic surfactant may be a surfactant selected from the group of alkyl ammonium salts; salts of fatty acids; bile salts; fusidic acid; fatty acid conjugates of amino acids, oligopeptides, and polypeptides; glyceride esters of amino acids, oligopeptides, and polypeptides; acyl lactylates; mono- and diacetylated tartaric acid esters of mono- and diglycerides; succinylated monoglycerides; lecithins and hydrogenated lecithins; citric acid esters of mono- and diglycerides; alginate salts; propylene glycol alginate; lysolecithin and hydrogenated lysolecithins; lysophospholipids; camitine fatty acid ester salts; sodium docusate; phospholipids; salts of alkylsulfates; and mixtures thereof.

Specific examples of hydrophilic surfactants include myristamidopropyl betaine, oleic acid diethanolamide, POE (40) tert-octylohenol, PEG 1000, POE(5) coco-amine, POE(20) nonylphenol, POE(50) nonylphenol, ethoxylated methyl glucoside dioleate, sodium lauryl sulfate, POE sodium lauryl ether sulfate, POE (9 to 10) nonylphenol, dihydrogenated tallow dimethyl ammonium chloride, stearic acid diethanolamide, solid dishwasher detergent, dicoco amine, triethanolamine stearate, potassium linoleate, dimethylstearylamine oxide, and POP 2500/20% EtO.

It should be noted that in some embodiments, the initiator and/or the hydrophobic material may comprise a mixture of surfactants, as many of the commercially available surfactants are mixtures of surfactants instead of a single surfactant. In some such cases, the polarity of the surfactants may be a polarity of the predominate species in the surfactant mixture, or an average polarity of the surfactants in the mixture. In embodiments where the mixtures of surfactants are non-ionic surfactants, the HLB value of non-ionic surfactants may be a HLB value of the predominate species in the surfactant mixture, or an average HLB value of the surfactants in the mixture. As such, it should be understood that the HLB value of a surfactant may provide a rough guideline for selection of non-ionic surfactants used in industrial, pharmaceutical and cosmetic formulation. Different commercial products having the same primary surfactant component can, and typically do, have different HLB values. Keeping these inherent difficulties in mind, and using HLB values as a guide, one skilled in the art can readily identify surfactants having suitable hydrophilicity or hydrophobicity for use in the present disclosure, as described herein.

In some embodiments, an initiator and/or a hydrophobic material may comprise a mixture of surfactants with the same or different polarities. For instance, the initiator may include a mixture of surfactants containing predominantly hydrophilic surfactants and a small amount of a hydrophobic surfactant, such that the surfactant mixture is still substantially hydrophilic. Similarly, the hydrophobic material may comprise a mixture of surfactants containing predominantly hydrophobic surfactants and a small amount of a hydrophilic surfactant, such that the surfactant mixture is still substantially hydrophobic.

In some embodiments, an initiator makes up a relatively small amount of a composition that includes the aluminum slurry, water, and the initiator, as described previously. In some cases, the initiator may be present in an amount of greater than or equal to greater than or equal to 0.0001 wt %, greater than or equal to 0.0005 wt %, greater than or equal to 0.001 wt %, greater than or equal to 0.005 wt %, greater than or equal to 0.01 wt %, greater than or equal to 0.05 wt %, greater than or equal to 0.1 wt %, greater than or equal to 0.5 wt %, or greater than or equal to 1 wt % of a total weight of the composition. In some cases, the initiator may be present in an amount of less than or equal to 5 wt %, less than or equal to 1 wt %, less than or equal to 0.5 wt %, less than or equal to 0.1 wt %, less than or equal to 0.05 wt %, less than or equal to 0.01 wt %, less than or equal to 0.005 wt %, less than or equal to 0.001 wt %, or less than or equal to 0.0005 wt % of a total weight of the composition. Combinations of the above-referenced ranges are also possible (e.g., greater than or equal to 0.0001 wt % and less than or equal to 1 wt %, greater than or equal to 0.0001 wt % and less than or equal to 1 wt %, or greater than or equal to 0.001 wt % and less than or equal to 0.1 wt %). Other ranges are also possible.

In some embodiments, the aluminum slurry may make up a variety of suitable weight percent of the composition containing aluminum slurry, water, and the initiator, as described herein. In some embodiments, the aluminum slurry may make up greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, or greater than or equal to 80 wt % of a total weight of the composition. In some embodiments, the aluminum slurry may make up less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt % of a total weight of the composition. Combination of the above-referenced ranges are also possible (e.g., greater than or equal to 10% and less than or equal 90% of a total weight of the composition). Other ranges are also possible. In some embodiments, the aluminum slurry may be present in an amount in the composition such that the composition contains a stochiometric amount of aluminum and water, as shown by Eq. (1).

In some embodiments, the hydrophobic material and the initiator may be present in a variety of weight ratios in a composition comprising an aluminum slurry, water, and an initiator. In some embodiments, the weight ratio of the hydrophobic material to the initiator may be greater than or equal to 1:10000, greater than or equal to 1:5000, greater than or equal to 1:1000, greater than or equal to 1:500, greater than or equal to 1:100, greater than or equal to 1:10, greater than or equal to 1:5, greater than or equal to 1:1, greater than or equal to 2:1, greater than or equal to 5:1, or greater than or equal to 10:1. In some embodiments, the weight ratio of the hydrophobic material to the initiator may be less than or equal to 10:1, less than or equal to 5:1, less than or equal to 2:1, less than or equal to 1:1, less than or equal to 1:2, less than or equal to 1:5, less than or equal to 1:10, less than or equal to 1:100, less than or equal to 1:500, less than or equal to 1:1000, or less than or equal to 1:5000. Combinations of the above-referenced ranges are also possible (e.g., greater than or equal to 1:1000 and less than or equal to 1:1). Other ranges are also possible.

In some embodiments, an aluminum slurry described herein may include additives. For instance, the additives may include rheology modifiers that can be used to tune or control the fluidic behavior of the aluminum slurry. For example, in some cases, these additives may be used to adjust the flow or rheological properties (e.g., viscosity, storage modulus G′, viscous modulus G″, etc) of the aluminum slurry. Non-limiting examples of such additives include, but is not limited to fumed silica, bentonite, and kaolin. For instance, in some embodiments, the aluminum slurry may exhibit a non-Newtonian behavior, such that the slurry shear thickens when subjected to a shear stress. In some such embodiments, rheology modifiers may be added to the aluminum slurry to enhance the flowability of the slurry (e.g., prevent shear thickening behavior), such that the aluminum slurry can be more easily processed or flowed during operation. For instance, the addition of the rheology modifiers may transform the rheology behavior of the aluminum slurry from a shear thickening fluid to a Newtonian fluid, or in some cases, to a shear thinning fluid.

Alternatively or additionally, the additives may include an anti-foam. For instance, in some embodiments, the fluid carrier described herein may increase the overall surface tension of the slurry, thereby creating foams and bubbles that may be unfavorable during a chemical reaction or operation. In some such embodiments, an antifoam may be incorporated to the aluminum slurry to suppress foam formation by reducing overall surface tension of the slurry. Any appropriate antifoams may be used. Non-limiting examples of such antifoam include, but is not limited to POP 2500/20% EtO, stearic acid, dishwasher detergent.

In some embodiments, the additives may be present in any appropriate amount in the aluminum slurry. In some embodiments, the additives may be present in an amount of greater than or equal to 0.005 wt %, greater than or equal to 0.01 wt %, greater than or equal to 0.05 wt %, greater than or equal to 0.1 wt %, greater than or equal to 0.2 wt %, greater than or equal to 0.3 wt %, greater than or equal to 0.4 wt %, greater than or equal to 0.5 wt %, greater than or equal to 0.6 wt %, greater than or equal to 0.7 wt %, greater than or equal to 0.8, or greater than or equal to 0.9 wt % of the aluminum slurry. In some embodiments, the additives may be present in an amount of less than or equal to 1 wt %, less than or equal to 0.9 wt %, less than or equal to 0.8 wt %, less than or equal to 0.7 wt %, less than or equal to 0.6 wt %, less than or equal to 0.5 wt %, less than or equal to 0.4 wt %, less than or equal to 0.3 wt %, less than or equal to 0.2 wt %, less or equal to 0.1 wt %, or less than or equal to 0.05 wt % of the total weight of aluminum slurry. Combinations of the above-referenced ranges are also possible (e.g., greater than or equal to 0.01 wt % and less than or equal to 1 wt %). Other ranges are also possible.

It should be noted that when an aluminum slurry includes two or more types of additives, each type of additives may independently make up an amount of the aluminum slurry in the aluminum slurry in one or more of the ranges described above and/or all of the additives in an aluminum slurry may together make up an amount of the additives in the aluminum slurry in one or more of the ranges describe above.

In accordance with certain embodiments, the reaction between the plurality of activated aluminum particles and water may be controlled by the presence of a hydrophobic material (e.g., hydrophobic surfactants) and an initiator (e.g., hydrophobic surfactants). According to certain embodiments, whereas the hydrophobic material, by forming a surface layer around the plurality of activated aluminum particles, may be configured to inhibit reaction between the aluminum and water, the initiator may be configured to disrupt and/or displace the surface layer to permit the reaction between the aluminum and water. In addition to acting as an on and off switch for the reaction between aluminum and water, the hydrophobic material and initiator may be used to control the reaction rates. For instance, the reaction may be limited by the rate of diffusion of water molecules into the surface layer as well as the rate of disruption of the surface layer. Accordingly, parameters such as the ratio of initiator to hydrophobic material, the type of initiator, the amount of hydrophobic material relative the number of particles, the thickness of the surface layer, the degree of coating by the surface layer (e.g., partially coated versus fully coated), may affect the rate at which the water molecules can penetrate the surface layer and gain contact with the aluminum particles. For instance, in some embodiments, an initiator selected from a first class of surfactants may lead to a faster disruption or displacement of the surface layer compared to an initiator from a second class of surfactants, and thus may result in a faster reaction between aluminum and water. Accordingly, by adjusting the abovementioned parameters, the reactivity of the aluminum slurry can be tuned to a desired rate.

In some embodiments, the reaction between the plurality of activated aluminum particles and water may be controlled by the presence of a hydrophobic material and an initiator, in addition to a change in temperature. As mentioned, in some embodiments, a surface layer disposed on the plurality of activated aluminum particles may contain a hydrophobic material that has a melting temperature that is below the operating temperature (e.g., 100° C.) inside the reactor. That is, the surface layer may act as a solid barrier that inhibits the reaction between aluminum and water, until being subjected to at an operating temperature above its melting point inside the reactor. In some such embodiments, the solid surface layer phase may undergo a phase transition inside the reactor and transforms from a solid impermeable surface layer into a liquid surface layer that encapsulated the activated aluminum particles. Accordingly, an initiator may interact with/penetrate into the liquid surface layer and disrupt the surface layer, such that the activated aluminum particle may be released from the surface layer to a surrounding environment.

Alternatively or additionally, the reaction between the plurality of activated aluminum particles and water may be primarily modulated by a temperature change inside a reactor. As mentioned, the surface layer may contain a hydrophobic material that may have a melting point below an operating temperature inside the reactor, as described elsewhere herein. In some such embodiments, the surface layer can be melted away and/or solubilized into the fluid carrier at the operating temperature and release the aluminum particle to the surrounding environment. It should be noted in embodiments where temperature is relied upon as the primary factor in modulating the reaction, the addition of initiator to the aluminum slurry may be optional.

Alternatively or additionally, the particle size of the activated aluminum particles may be modulated to tune the reactivity between the aluminum particles and water. In some such embodiments, when the activated aluminum particles are reduced to a sufficiently small size, a surface layer is no longer needed to inhibit the reaction between the particles and the surrounding environment (e.g, water). Without wishing to be bound by theory, it has been hypothesized that for particles having a sufficiently small size, a fluid carrier alone may be sufficient in providing a barrier between the activated aluminum particles and water to prevent the reaction between aluminum and water from occurring. In some such embodiments, the small particles may stay suspended in the fluid carrier and remain unreactive until initiators have been added to the composition. In some such embodiments, the particles may have a sufficiently small size of less than or equal to 10 microns, or in certain instances, as large as 1000 μm.

In some embodiments, methods of making and using the aluminum slurry are provided herein. As mentioned, according to certain embodiments, solid aluminum may be treated with an activating composition described herein to increase it reactivity with water. The activated solid aluminum may have any appropriate initial physical form including plates, pellets, blocks, and/or any other form as the disclosure is not limited in this fashion.

In accordance with certain embodiments, the activated aluminum may be processed into an aluminum slurry that includes a plurality of activated aluminum particles dispersed in a fluid carrier (e.g., oil and/or alcohol). In some embodiments, the shape and/or size of the activated aluminum particles may be tailored to a size suitable for the specific application using methods understood to a person of ordinary skill in art. For example, in some embodiments, the size of the activated aluminum particles may be altered using milling (e.g. ball mill, cryo-mill, rotor mill, knife mill, jet mill, colloidal mill etc.) and/or jet cutting, laser cutting, mortar and pestle, and/or any other appropriate manufacturing method that is capable of producing a plurality of activate aluminum particles described herein. For instance, in one set of embodiments, a colloidal mill may be used to grind a mixture comprising the activated solid aluminum, a fluid carrier, a hydrophobic material, and other potential additives into the aluminum slurry described herein.

In some embodiments, the resultant aluminum slurry may be combined with water to form a composition in a reactor. As mentioned, according to some embodiments, the aluminum slurry in the composition is relatively unreactive with the surrounding environment (e.g., water), possibly due to the presence of the surface layer disposed on the plurality of activated aluminum particles and/or the presence of the fluid carrier. As mentioned, the timing and the rate of the reaction between aluminum and water may be modulated by the presence of an initiator. For instance, the initiator may be added to the composition containing the aluminum slurry and water to permit a reaction between the aluminum slurry and water.

It should be noted that although the current disclosure is directed to aluminum slurry, other reactive metals in a slurry form may be used. In some such embodiments, the reactant may include aluminum, as described above with relation to Eq. (1). However, other metals may also be used depending on the particular embodiment. Non-limiting examples of reactive metals that may be used are aluminum, lithium, sodium, magnesium, zinc, boron, beryllium, and/or any other reactive metal capable of reacting with water to generate hydrogen and/or heat.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

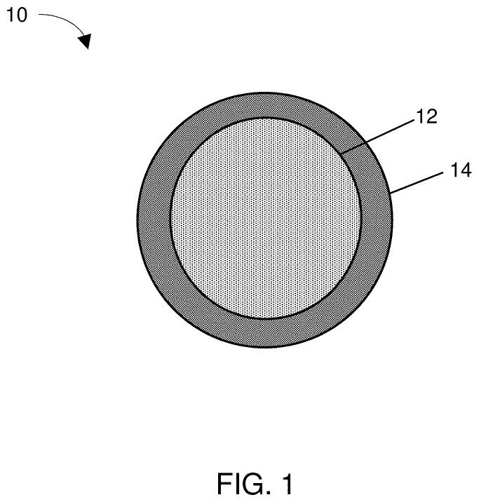

FIG. 1 shows a non-limiting representation of an activated aluminum particle described herein. As shown, article 10 includes an activated aluminum particle 12 and a surface layer 14 disposed on the surface of the activated aluminum particle. As mentioned, the activated aluminum particle may be activated with an activating composition, e.g., aluminum combined with gallium and/or indium, and the surface layer may have any appropriate material properties (e.g., melting point, size, and shape) as described previously. In addition, the surface layer may include any appropriate hydrophobic material (e.g., a hydrophobic surfactant and/or a lipid) disclosed herein that has an affinity to the surface of the activated aluminum particles.

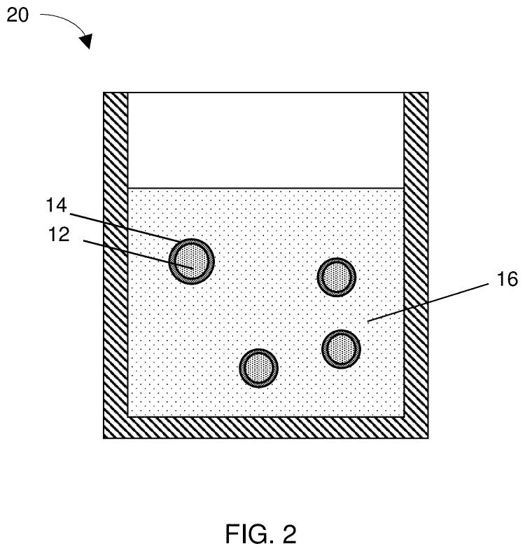

FIG. 2 shows an aluminum slurry 20 containing a plurality of activated aluminum particles dispersed in a fluid carrier. As shown in the figure, a plurality of activated aluminum particles 12 may be uniformly dispersed in a fluid carrier 16. Each of the plurality of activated aluminum particles 12 may be at least partially coated by a surface layer 14. The fluid carrier may be any suitable oil and/or alcohol disclosed herein (e.g., an oil that has a freezing point of less than or equal 20° C., or any other appropriate temperature based on a desired application).

In some embodiments, the surface layer 14 encapsulating the activated aluminum particle 12 in the aluminum slurry 20 may be a solid surface layer. For instance, the surface layer may contain a hydrophobic material that has a melting point greater than the storage temperature of the aluminum slurry (e.g., 20° C.). In some such embodiments, the solid surface layer may have a melting pointing of less than or equal to an operating temperature (e.g., 100° C.) inside a reactor, such that the surface layer in the aluminum slurry phase transitions from a solid coating to a liquid coating inside the reactor.

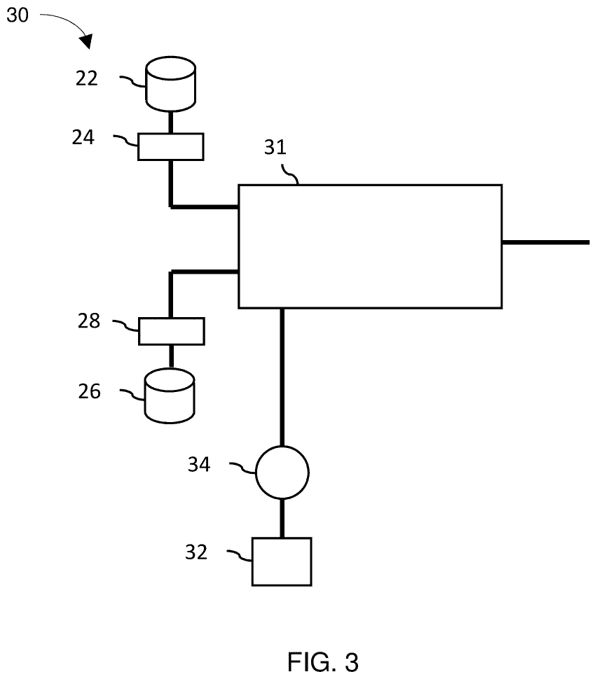

According to some embodiments, a composition described herein may include an aluminum slurry, water, and an initiator uniformly dispersed in the composition, where the initiator can be used to disrupt a surface layer disposed on the plurality of activated aluminum particles to permit a reaction between the plurality of activated aluminum particles in the aluminum slurry and the surrounding water. FIG. 3 shows a non-limiting representation of a reactor system that may be used for combining the aluminum slurry, water, and initiator together to form the composition described herein and carrying out the reaction between the activated aluminum particles and water. It should be noted that the reaction chamber may be operated at an operating temperature (e.g., 100° C.) that is greater than a melting temperature of the hydrophobic material contained in the surface layer.

As shown in FIG. 3, an aluminum slurry reservoir 22, a water reservoir 26, and a reservoir 32 containing initiators are operatively coupled to a reactor chamber 31. Additionally, various feeders (e.g., an aluminum slurry feeder 24, a water feeder 28, and an initiator feeder 34 for feeding the initiator) may be positioned between the reactor and the respective reservoirs as shown. The feeders are configured to provide a desired ratio of water to aluminum slurry to initiators to the reactor chamber. In such an embodiment, the feeders may be a valve selected from the group of a gate valve, a ball valve, a butterfly valve, or any other suitable valve that may be selectively opened or closed to control the flow of the respective materials from the reservoirs.

While the use of valves is described above, the various feeders may correspond to other constructions as detailed below. For example, other flow control devices may be used instead of the described valves. In one such embodiment, any appropriate type of feeder capable of transporting water and/or reactant from a corresponding reservoir to the reactor chamber may be used. Appropriate types of feeder systems may include, but are not limited to, a pump, a belt feeder, a scoop feeder, a screw feeder, and/or any other appropriate type of construction capable of transporting a desired amount of material from the associated reservoir to the reactor chamber depending on the form of the initiator, reactant, and/or water (e.g., slurry, fluid, solid, etc.). In such embodiments, the aluminum slurry, water, and/or initiator may be pumped into the reactor chamber using one or more pumps. For example, the aluminum slurry may be urged through one or more valves and/or into the reactor chamber by using a pump. It should be noted that the reactor may have any appropriate operating temperature as described previously. The reactor may also be operated under any appropriate pressure (e.g., atmospheric pressure).

As mentioned, according to some embodiments, aluminum slurry from the aluminum slurry reservoir 22 may be first combined with water from the water reservoir 26 in the reactor 31 prior to adding an initiator. The aluminum slurry and water mixture may be subjected to a mixing in the reactor. It should be noted that the aluminum slurry may be stable and unreactive in the presence of water. Next, an initiator may be passed from the reservoir 32 into the reactor and combined with the aluminum slurry and water mixture. As mentioned, in the presence of the initiators, the plurality of aluminum particles may react with water to produce hydrogen, aluminum hydroxide, and heat. Although not shown in FIG. 3, the reaction products may be collected and stored for future use. Alternatively, the reaction products may be used in an inline device as the disclosure is not so limited. Additionally, the remaining fluid carrier from the reacted aluminum slurry may be collected downstream of the reactor and utilized in energy conversion devices such as engines or fuel cells.

It should be noted that the order of addition of various components into the reactor is not limited to the above. For instance, in some embodiments, the various components (e.g., aluminum slurry, water, initiator) may be combined into a composition prior to being fed into the reactor. In some such cases, the surface layer on the plurality of aluminum particles in the aluminum slurry may be a solid coating or surface layer that acts as a physical barrier to both the surrounding water and initiator, such that no reaction between aluminum and water may occur. As the composition is fed into the reactor, the solid surface layer may melt into a liquid coating, and the initiator may disrupt the liquid coating to release the aluminum particles to permit the reaction between water and aluminum.

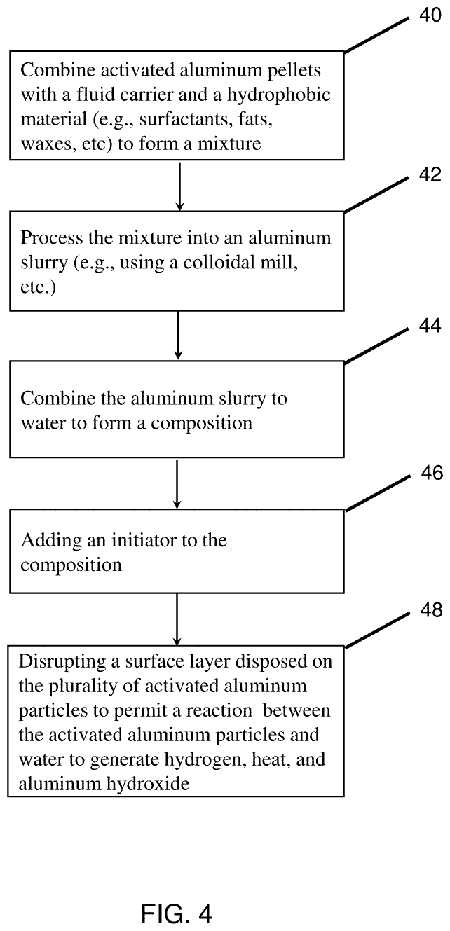

FIG. 4 is a flow diagram illustrating the methods of making and using an aluminum slurry described herein, according to certain embodiments. First, a plurality of activated aluminum pieces (e.g., pellets, etc.) may be combined with a fluid carrier (e.g., oil and/or alcohol) and a hydrophobic material to form a mixture (e.g., 40 in FIG. 4). The mixture may be fed into and processed in any suitable equipment (e.g, a colloidal mill, a ball mill, a mortar and pestle setup, etc.) to produce the aluminum slurry (e.g., 42 in FIG. 4). It should be noted that in some embodiments, the components within the mixture may be added to the equipment (e.g., colloidal mill) independently without prior mixing. For instance, a fluid carrier may be first fed to a colloidal mill, followed by incremental addition of activated aluminum pellets, and then the hydrophobic materials. The hydrophobic materials may be fed into the colloidal mill either as a molten liquid or as a solid that can be subsequently melted inside the colloidal mill during grinding, as long as a uniform surface layer may be coated onto the plurality of activated aluminum particles. The hydrophobic materials may be fed into the mill, before, during, or after the addition of the activated aluminum pellets. According to certain embodiments, the resultant aluminum slurry may be independent of the order of addition of the individual components to the mill. The resulting aluminum slurry may have any properties (e.g., size, shape, structure) described previously, as shown in FIG. 2.

Next, the aluminum slurry may be combined with water to form a composition in the reactor (e.g., 44 in FIG. 4). As mentioned, according to certain embodiments, the aluminum slurry is stable and unreactive in the presence of water, e.g., a water-stable aluminum slurry. It should be noted that surface layer disposed on the aluminum particles may include a hydrophobic material that has a melting pointing of less than or equal to an operating temperature inside a reactor. Any appropriate hydrophobic material described herein may be used.

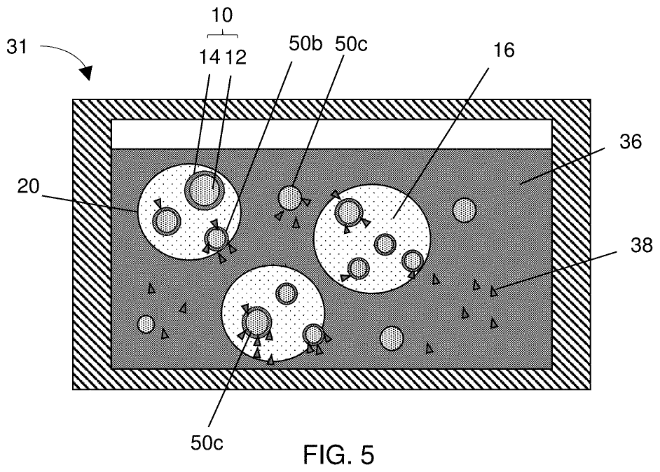

Next, an initiator (e.g., a hydrophilic surfactant) may be added to the composition containing the aluminum slurry (e.g., 46 in FIG. 4). Any appropriate initiators described elsewhere herein may be used. Once the initiator has been added to the composition, the initiator may disrupt and/or displace a surface layer (e.g., a liquid surface layer) disposed on the plurality of activated aluminum particles and permit a reaction between the plurality of activated aluminum particles in the aluminum slurry and water (e.g., 48 in FIG. 4). Accordingly, the reaction between the plurality of activated aluminum particles in the aluminum slurry and water may generate hydrogen, heat, and aluminum hydroxide. FIG. 5 is a schematic representation of 48 in FIG. 4.

FIG. 5 shows a reactor 31 containing a composition of water, an initiator, and an aluminum slurry, according to certain embodiments. As shown, an aluminum slurry 20, which may be similar to that described above relative to FIG. 2, may contain a plurality of activated aluminum particles 12 dispersed in a fluid carrier 16 which may be combined with water 36 in a reactor 31. As shown, the aluminum particle 12 inside the aluminum slurry may be at least partially coated by a surface layer 14 (e.g., similar to FIG. 1). It should be noted that the surface layer may include a hydrophobic material that has a melting point of less than or equal to an operating temperature inside the reactor, such that the surface layer is in a liquid state when inside the reactor. Next, an initiator 38 (e.g., a hydrophilic surfactant) may be introduced into the composition to disrupt the surface layer. According to some embodiments, the initiator, as a hydrophilic surfactant, may exhibit a greater solubility in the aqueous phase (e.g., water 36), but also a small amount of solubility in the oil phase (e.g., fluid carrier 16) of the aluminum slurry 20. As such, the initiator 38 may diffuse into the fluid carrier of the aluminum slurry and disrupt the surface layer encapsulating the activated aluminum particle 50b. As the surface layer becomes disrupted or displaced, the active aluminum particle 50b may become destabilized and leave the fluid carrier, as shown by the activated aluminum particle 50c. Accordingly, when the activated aluminum particle 50c is exposed to water, a reaction between the aluminum particle and water may be take place.

Alternatively or additionally, the reaction between the activated aluminum particle and water may take place inside the fluid carrier. For instance, as shown, the initiator may diffuse into the fluid carrier and interact with the surface layer around a particle 50c inside the fluid carrier. Because of the water-soluble nature of the initiator, the initiator solubilized in the fluid carrier and in the surface layer may provide a path for water molecules to diffuse into the surface layer and react with the aluminum particles 50c inside the fluid carrier.

### Example

Treated aluminum fuel activated with indium and gallium was converted to a liquid form by slurrying it with an oil or alcohol. The raw aluminum slurry acted much like cement, or wet sand and, as such, was difficult to pump with conventional equipment. It exhibited a non-Newtonian behavior, and “locked up” (e.g., shear thickened) when stressed. To prevent the aluminum slurry from locking up, additives were added to help separate the particles in the aluminum slurry, and to allow the slurry flow better. Some of those additives included fumed silica, bentonite, and kaolin. A small amount of these additives (<1% by mass) was used to change the fluidic properties of the aluminum slurry from that similar to that of a cement to that of peanut butter or toothpaste.

To prevent the reaction of aluminum and water a particle surface coating was applied. For example, some materials, such as tallow, were able to cover the activated aluminum particles and inhibited the water from reacting with the particles. This confirmed that is was possible to enable an entirely new paradigm for controlling the aluminum-water reaction using a slurry via a “lock and key” reaction. It was discovered that if a counter surfactant was added to the water to counter or displace the surfactant on the aluminum, the reaction could be rapidly initiated. This was akin to cutting grease with soap. The water-stable aluminum slurry only reacted when the appropriate “key” was added to the water. Similarly, waxes and fats like tallow may also be tuned to melt at a certain temperature, thereby liberating the aluminum and initiating the reaction.

In addition to the above, while a smooth-flowing aluminum paste was highly desirable for chemical reactor design, the oil increased the surface tension of the slurry and led to the formation of bubbles and foam during the reaction between aluminum and water. The foam was mitigated using surfactants such as POP 2500/20% EtO or stearic acid.

A paste was made from very finely ground aluminum powder (<230 mesh, dry) and well mixed with mineral oil. The paste was extremely slow to react with water. Without wishing to be bound by theory, this phenomenon was hypothesized to be driven by the immiscibility of water and oil and the high surface area created by the fine particles. Experiments were conducted to assess the performance of surfactants in increasing reaction rate of wettability-bound pastes, with the intent that the surfactant be the “key” to the “lock” of a very fine and slow reacting paste.

A surfactant kit (list of all contained chemicals attached) containing various surfactants to screen many types of surfactant for performance was acquired from ChemService Inc. Examples of surfactants tested included POE (6) tridecyl alcohol ether, POE (24) cholesterol, PEO (40) tert-octylphenol, POE (1 to 2) nonylphenol, POE (9 to 10) nonylphenol, nonylphenoxy poly(ethyleneoxy)ethanol (branched, POE 10.5-11), POE (20) nonylphenol, POE (30) nonylphenol, POE (50) nonylphenol, POE (150) dinonyl phenol, POE (5) dodecyl phenol, tetramethyl decynediol, P.O.P. 2500/20% EtO, P.O.P 4600/50% EtO, sodium 2-ethylhexyl sulfate, sodium lauryl sulfate, potassium lauryl sulfate, sodium cetyl/stearyl sulfate, sodium sec-heptadecyl sulfate (25-27% in water), ammonium lauryl sulfate, POE (2) sodium lauryl ether sulfate, POE (3.5) sodium lauryl ether sulfate, sodium toluene sulfonate, sodium dodecylbenzene sulfonate (branched alkyl chain), triethanolammonium dodecylbenzene sulfonate, potassium polymerized alkyl-naphthalene sulfonate, ammonium monoethylphenyl-phenol monosulfonate, sodium decyl diphenyl ether disulfonate, sodium dihexyl sulfosuccinate, tallow amine, dicoco amine, potassium linoleate, POE (5) coco amine, N-b-Hydroxyethyl oleyl imidazoline, N-stearyl-N′N′-diethylethylenediamine acetate, ammonium laurate, disodium-N-lauryl-b-imino dipropionate (30% in water), myristamidopropyl betaine, stearic acid diethanolamide, Erucamide, lauric acid monoethanolamide, oleic acid diethanolamide, POE hydrogenated tallow amide (5 moles EtO), dehydrogenated tallow dimethyl ammonium chloride, methyldodecylbenzyl trimethyl ammonium chloride, sodium tetraborate decahydrate, PEG 1000, dimethylstearylamine oxide, ethoxylated methyl glucoside dioleate, morpholine stearate, triethanolamine laurate, and triethanolamine stearate.

To address foaming that was observed in some reactions, a paste was prepared by grinding activated aluminum dry until it was fine enough to pass a 230 mesh, then mixed with oil and thickeners (fumed silica, bentonite). A small amount of paste was added to heated water (60 C) in a glass vessel, then a small amount (<5 ml for liquid surfactants) of surfactant was mixed in. Each sample was observed and judged against control (paste without surfactant) for reaction speed and foam formation. The goal was to find a surfactant that speeds the reaction significantly with a minimum of added foam production.

Surfactants were tested individually, and no blend testing was performed. Surfactants are generally blended with one another to increase performance and modify foam formation. Silicone oil and other commercially available polymer defoamers were also tested to reduce foam production, but foam reduction generally came at the cost of reaction rate.

In particular, myristamidopropyl betaine, POP 2500/20% EtO, Stearic acid diethanolamide, POE(5) coco-amine, oleic acid diethanolamide, POE (40) tert-octylohenol, Dicoco Amine, POE(20) nonylphenol were the standout performers of the testing. While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

1. An aluminum slurry, comprising:
a plurality of activated aluminum particles dispersed in a fluid carrier, wherein the activated aluminum particles comprises aluminum combined with gallium and/or indium; and
a surface layer disposed on the plurality of activated aluminum particles, wherein the surface layer comprises a hydrophobic material having an affinity to the surface of the activated aluminum particles, wherein the hydrophobic material has a melting point of greater than 20° C. and less than or equal to 100° C.

2. The aluminum slurry of claim 1, wherein each of the plurality of activated aluminum particles is at least partially coated by the surface layer.

3. The aluminum slurry of claim 1, wherein the hydrophobic material comprises a hydrophobic surfactant and/or a lipid.

4-5. (canceled)

6. The aluminum slurry of claim 1, wherein the hydrophobic material comprises at least one selected from the group of a fat, a tallow, an aluminum stearate, a fatty acid, a wax, and a grease.

7. The aluminum slurry of claim 1, wherein the hydrophobic material is present in an amount of less than or equal to 5 wt % of the slurry.

8. The aluminum slurry of claim 1, wherein the fluid carrier has a freezing point of less than or equal 20° C.

9-10. (canceled)

11. The aluminum slurry of claim 1, wherein the fluid carrier comprises an oil and/or an alcohol selected from the group of mineral oil, diesel fuel, petroleum-based products, food-grade oils, and branched alcohols.

12-13. (canceled)

14. The aluminum slurry of claim 1, wherein the plurality of active aluminum particles has a particles size of less than or equal to 100 um.

15. A composition comprising:
an aluminum slurry comprising:
a plurality of activated aluminum particles dispersed in a fluid carrier, wherein the activated aluminum particles comprise aluminum combined with gallium and/or indium; and
a surface layer disposed on the plurality of activated aluminum particles, wherein the surface layer comprises a hydrophobic material having an affinity to the surface of the activated aluminum particles; and
an initiator uniformly dispersed in the composition, wherein the initiator comprises a hydrophilic surfactant selected from the group of non-ionic and ionic surfactants.

16. The composition of claim 15, further comprising water.

17-18. (canceled)

19. The composition of claim 15, wherein the initiator is present in an amount of less than or equal to 1 wt % of the composition.

20. (canceled)

21. The composition of claim 15, wherein the initiator comprises at least one surfactant selected from the group of myristamidopropyl betaine, POP 2500/20% EtO, oleic acid diethanolamide, POE (40) tert-octylohenol, PEG 1000, POE(5) coco-amine, POE(20) nonylphenol, POE(50) nonylphenol, ethoxylated methyl glucoside dioleate, sodium lauryl sulfate, POE sodium lauryl ether sulfate, POE (9 to 10) nonylphenol, dihydrogenated tallow dimethyl ammonium chloride, stearic acid diethanolamide, dishwasher detergent, dicoco amine, triethanolamine stearate, potassium linoleate, and dimethylstearylamine oxide.

22. The composition of claim 15, wherein the hydrophobic material comprises a hydrophobic surfactant and/or a lipid.

23. (canceled)

24. The composition of claim 15, wherein the hydrophobic material has a melting point of greater than 20° C. and less than or equal to 100° C.

25. (canceled)

26. The composition of claim 15, wherein the fluid carrier comprises a material selected from the group of mineral oil, diesel fuel, petroleum-based products, and food-grade oils.

27. A method of using an aluminum slurry, comprising:
adding an initiator to a composition containing an aluminum slurry, wherein the aluminum slurry comprise a plurality of activated aluminum particles dispersed in a fluid carrier, wherein the activated aluminum particles comprises aluminum combined with gallium and/or indium; and
disrupting a surface layer disposed on the plurality of activated aluminum particles with the initiator to permit a reaction between the plurality of activated aluminum particles in the aluminum slurry and water.

28. The method of claim 27, further comprising combining the aluminum slurry with water to form the composition prior to adding the initiator.

29-30. (canceled)

31. The method of claim 27, wherein the initiator comprises at least one surfactant selected from the group of myristamidopropyl betaine, POP 2500/20% EtO, oleic acid diethanolamide, POE (40) tert-octylohenol, PEG 1000, POE(5) coco-amine, POE(20) nonylphenol, POE(50) nonylphenol, ethoxylated methyl glucoside dioleate, sodium lauryl sulfate, POE sodium lauryl ether sulfate, POE (9 to 10) nonylphenol, dihydrogenated tallow dimethyl ammonium chloride, stearic acid diethanolamide, dishwasher detergent, dicoco amine, triethanolamine stearate, potassium linoleate, and dimethylstearylamine oxide.

32-34. (canceled)

35. The method of claim 27, wherein the hydrophobic material comprises a hydrophobic surfactant and/or a lipid.

36-37. (canceled)

38. The method of claim 27, wherein the fluid carrier comprises a material selected from the group of mineral oil, diesel fuel, petroleum-based products, and food-grade oils.
